(19) United States
(12) Patent Application Publication
(10) Pub. No.: US 2023/0242390 A1
(43) Pub. Date: Aug. 3, 2023

(54) LASER ALIGNMENT TOOL FOR CAPPING HEADS IN A CAPPING MACHINE

(71) Applicants: Mike Scott, Midland, MI (US); Michael Degraw, Shepherd, MI (US)

(72) Inventors: Mike Scott, Midland, MI (US); Michael Degraw, Shepherd, MI (US)

(21) Appl. No.: 17/649,695

(22) Filed: Feb. 2, 2022

(51) Int. Cl. B67B 3/26

(52) U.S. Cl. CPC B67B 3/264

(57) ABSTRACT

A laser alignment tool for capping heads. The laser alignment tool comprising in combination an adapter housing that is adaptable to a headset or spindle on a capping machine, a laser bore housing, a laser pointer contained in the laser bore housing and a laser center platform.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The applicant is unaware of any prior art in this field.

### BRIEF SUMMARY OF THE INVENTION

The present invention is a laser alignment tool for capping heads. The laser alignment tool comprises in combination an adapter housing that is threadably adaptable to a headset or spindle on a capping machine. There is a laser bore housing. The laser bore housing has a flat lower end. There is a laser pointer contained in the laser bore housing. The laser pointer has a lower end and there is mounted on the lower end, a dimple and a laser center platform.

Further contemplated within the scope of this invention is a laser alignment tool in combination in with a laser center platform mounted on the bottle retention knife.

Still further contemplated within the scope of tis invention is a laser alignment tool wherein the laser center platform has a lower end and the lower end contains a magnet.

### BRIEF DESCRIPTION OF THE SEVERAL VIEWS OF THE DRAWING(S)

FIG. 1A shows a full side view of the laser alignment tool of this invention.

FIG. 1B shows a side view of a laser center platform.

FIG. 2 shows an exploded view of the device of this invention.

FIG. 3 shows a cross sectional view of the laser alignment tool of FIG. 1A through line A-A of FIG. 1A.

### DETAILED DESCRIPTION OF THE INVENTION AND DRAWINGS

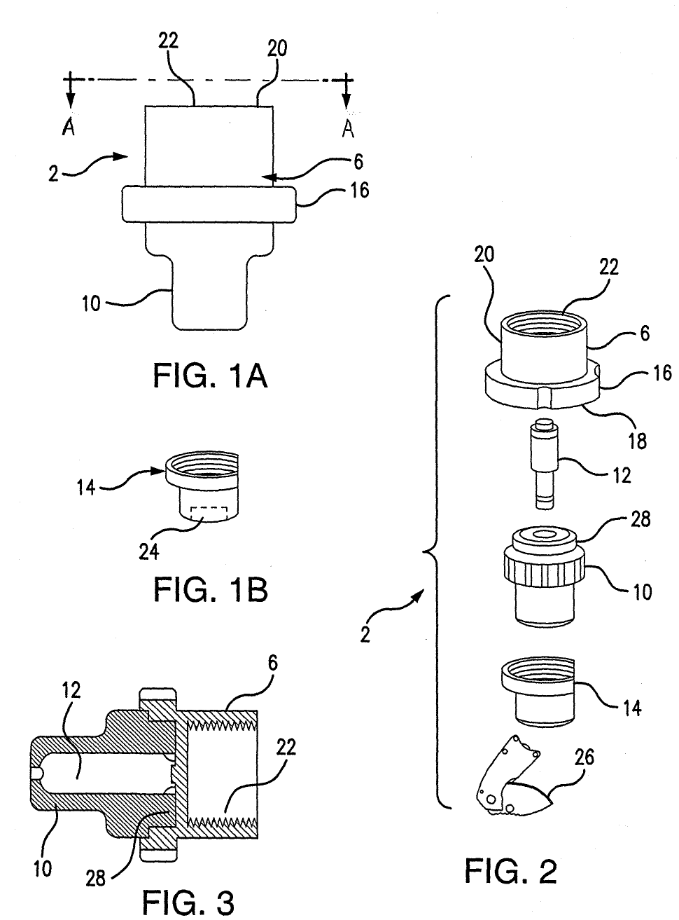

Turning to FIG. 1, FIG. 1 shows a full side view of the laser alignment tool 2. The laser alignment tool 2 comprises in combination, an adapter housing 6 that is adaptable to a headset or spindle on a capping machine (not shown and not part of the invention). There is a laser bore housing 10 and a laser pointer 12 contained in the laser bore housing 10, and a laser center platform 14 (FIG. 2). The near end 16 of the adaptor has an inside surface that is threaded 18. The distal end 20 of the laser bore housing has an inside surface 22 that is threaded.

FIG. 1B shows a side view of the laser centered platform 14. The laser centered platform 14 has a magnet 24 located therein.

FIG. 2 shows an exploded view of the device of this invention. The adaptor 6 is designed to house the laser bore housing 10 and the laser pointer 12. The near end 16 of the adaptor has an inside surface that is threaded 18. The distal end 20 of the laser bore housing has an inside surface 22.

Also shown is the laser bore housing 10 and the laser pointer 12. The laser center platform 14 with the magnet 16 is also shown. The bottle retention knife 26 is also shown.

FIG. 3 shows the adaptor housing 6 from the side. The laser pointer 12 slides inside the laser bore 10 and the adaptor screws on to the top 28 of the laser bore 10 securing the laser pointer 12 within the laser bore 10 and the adaptor 6.

The laser alignment tool 2 is mounted on a bottle capping machine. The laser alignment tool 2 lets the operator keep the capping chuck within certain parameters to improve the efficiency of the bottle capping chuck and the bottle capping machine with regard to alignment of the capping machine with the bottle end.

1. A laser alignment tool for capping heads, said laser alignment tool comprising in combination:
i. an adapter housing that is threadably adaptable to a headset or spindle on a capping machine;
ii. a laser bore housing, said laser bore housing having a flat lower end;
iii. a laser pointer contained in said laser bore housing, said laser pointer having a lower end and, mounted on said lower end, a dimple, and[,]
iv. a laser center platform.

2. The laser alignment tool as claimed in claim 1 in combination with a laser center platform mounted on a bottle retention knife.

3. The laser alignment tool as claimed in claim 1 wherein said laser center platform has a lower end and said lower end contains a magnet.
